(19) United States
(12) Patent Application Publication
(10) Pub. No.: US 2025/0047984 A1
(43) Pub. Date: Feb. 6, 2025

(54) Technologies for Improving Imaging System Wakeup and Indicia Decoding

(71) Applicant: ZEBRA TECHNOLOGIES CORPORATION, Lincolnshire, IL (US)

(72) Inventors: Edward Barkan, Miller Place, NY (US); Darran Michael Handshaw, Sound Beach, NY (US); Mark Drzymala, Saint James, NY (US)

(21) Appl. No.: 18/228,625

(22) Filed: Jul. 31, 2023

(51) Int. Cl. H04N 23/74; G06K 7/14; G06T 7/70; G06V 10/141

(52) U.S. Cl. CPC H04N 23/74; G06K 7/1447; G06T 7/70; G06V 10/141

(57) ABSTRACT

Technologies for improving imaging system wakeup and indicia decoding are disclosed herein. An example device includes an imaging device disposed proximate to a first edge of a weighing platter of an imaging system, and having a field of view (FOV) including a first object disposed proximate to a second edge of the weighing platter; an illumination source disposed proximate to the first edge of the weighing platter, the illumination source being configured to emit illumination oriented towards the first object; and one or more processors. The one or more processors being configured to: cause the illumination source to emit illumination, cause the imaging device to capture image data representative of an environment appearing within the FOV, determine that a second object satisfies a position threshold relative to at least one of the imaging device or the first object, and generate a wakeup signal to activate the imaging system.

### BACKGROUND

Traditionally, bioptic imaging devices utilize a wakeup system to transition the imaging components contained therein from an inactive state to an active state, and thereby ready for image capture and indicia decoding. However, these conventional wakeup systems suffer from several drawbacks, such as inaccurate ranging and visibility to the user. These drawbacks can lead to erroneous system wakeups, delayed and/or otherwise inaccurate indicia decoding, user frustration and eye irritation, and other sub-optimal results.

Accordingly, there is a need for technologies for improving imaging system wakeup and indicia decoding to alleviate these issues associated with erroneous and irritating conventional wakeup systems.

### SUMMARY

Generally speaking, the systems and methods herein utilize an imaging device disposed proximate to an edge of a weighing platter that is configured to capture image data of an environment that may include a tower portion of a bioptic imaging device while the imaging devices within the bioptic imaging device are inactive. This imaging device may then analyze this captured image data determine whether an object satisfies a position threshold relative to at least one of the imaging device or the tower portion of the bioptic imaging device. If an object satisfies the position threshold, the imaging device may generate a wakeup signal to active the imaging system, comprised at least in part by the imaging devices within the bioptic imaging device.

Accordingly, in an embodiment, the present invention is a device for improving imaging system wakeup and indicia decoding. The device includes an imaging device disposed proximate to a first edge of a weighing platter of an imaging system, the imaging device having a field of view (FOV) including a first object disposed proximate to a second edge of the weighing platter; an illumination source disposed proximate to the first edge of the weighing platter, the illumination source being configured to emit illumination oriented towards the first object; and one or more processors configured to: cause the illumination source to emit illumination, cause the imaging device to capture image data representative of an environment appearing within the FOV, determine, based on the image data, that a second object satisfies a position threshold relative to at least one of the imaging device or the first object, and generate a wakeup signal to activate the imaging system.

In a variation of this embodiment, the first object is a portion of a bioptic reader, the bioptic reader comprising: a second imaging device having a second field of view (FOV) oriented towards the first edge of the weighing platter; and a second illumination source associated with the bioptic reader, the second illumination source being configured to emit illumination oriented towards the first edge of the weighing platter. Further in this variation, the imaging system comprises at least the bioptic reader, and the wakeup signal causes the bioptic reader to: emit illumination via the second illumination source; capture second image data representative of at least a portion of the second object via the second imaging device; and analyze the second image data to (i) identify an indicia associated with the second object and (ii) decode the indicia.

In another variation of this embodiment, the illumination source and the imaging device are disposed at a first position proximate to the first edge of the weighing platter, and the wakeup device further comprises: a second imaging device disposed at a second position proximate to the first edge of the weighing platter that is different from the first position, the second imaging device having a second FOV including the first object, and the second imaging device being configured to capture second image data representative of a second environment appearing within the second FOV; and a second illumination source positioned at the second position, the second illumination source being configured to emit illumination oriented towards the first object. Further in this variation, the one or more processors are further configured to: cause the first imaging device and the second imaging device to capture a plurality of pairs of image data sets, wherein each pair of image data sets includes a respective second object in at least one image data set; determining that multiple pairs of image data sets from the plurality of pairs of image data sets includes respective second objects in only one image data set; and generating a cleaning alert corresponding to a respective imaging device that captured an image data set that did not include a respective second object.

In yet another variation of this embodiment, the one or more processors are further configured to: cause the imaging device to capture a first set of image data while the illumination source is inactive; after the imaging device captures the first set of image data, cause (i) the illumination source to emit illumination and (ii) the imaging device to capture a second set of image data; and determine an object differential brightness between a first set of pixel data representing the second object in the first set of image data and a second set of pixel data representing the second object in the second set of image data.

In still another variation of this embodiment, the image data includes at least a third object, and the one or more processors are further configured to: determine, based on the image data, that the second object satisfies the position threshold relative to at least one of the imaging device, the first object, or the third object; and generate the wakeup signal to activate the imaging system.

In yet another variation of this embodiment, the one or more processors are further configured to: responsive to generating the wakeup signal, causing the imaging device to capture subsequent image data representative of the environment; and determine whether an indicia is visible in the subsequent image data. Further in this variation, the illumination source is further configured to output an aiming pattern corresponding to the imaging system attempting to scan an indicia associated with the second object.

In still another variation of this embodiment, the one or more processors are further configured to: adjust an emission profile of the illumination source, such that the illumination source is further configured to emit the illumination over a first portion of the first object.

In another embodiment, the present invention is a method for improving imaging system wakeup and indicia decoding. The method comprises: emitting, by an illumination source disposed proximate to a first edge of a weighing platter of an imaging system, illumination oriented towards a first object disposed proximate to a second edge of the weighing platter; capturing, by an imaging device disposed proximate to the first edge of the weighing platter and having a field of view (FOV) including the first object, image data representative of an environment appearing within the FOV; determining, based on the image data, that a second object satisfies a position threshold relative to at least one of the imaging device or the first object; and generating a wakeup signal to activate the imaging system.

In a variation of this embodiment, the method further comprises: capturing, by the imaging device, a first set of image data while the illumination source is inactive; after the imaging device captures the first set of image data: emitting illumination from the illumination source, and capturing, by the imaging device, a second set of image data; and determining an object differential brightness between a first set of pixel data representing the second object in the first set of image data and a second set of pixel data representing the second object in the second set of image data.

In another variation of this embodiment, the image data includes at least a third object, and the method further comprises: determining, based on the image data, that the second object satisfies the position threshold relative to at least one of the imaging device, the first object, or the third object; and generating the wakeup signal to activate the imaging system.

In yet another variation of this embodiment, the method further comprises: responsive to generating the wakeup signal, capturing, by the imaging device, subsequent image data representative of the environment; and determining whether an indicia is visible in the subsequent image data.

In yet another embodiment, the present invention is a device for improving imaging system wakeup and indicia decoding. The device comprises: an imaging device disposed proximate to a first edge of a weighing platter of an imaging system, the imaging device having a field of view (FOV) including a first object disposed proximate to a second edge of the weighing platter; an illumination source disposed in the first object and configured to emit illumination oriented towards the imaging device; and one or more processors configured to: cause the illumination source to emit illumination, cause the imaging device to capture image data representative of an environment appearing within the FOV, determine, based on the image data, that a second object satisfies a position threshold relative to at least one of the imaging device or the illumination source, and generate a wakeup signal to activate the imaging system.

In a variation of this embodiment, the first object is a portion of a bioptic reader comprising a housing and an optical window, and the illumination source is associated with the bioptic reader and disposed within the housing and proximate to the optical window. Further in this variation, the portion of the bioptic reader includes a set of LED strips surrounding the optical window and configured to emit illumination oriented towards the imaging device.

In another variation of this embodiment, the illumination source is at least one of: (i) a lightpipe strip, (ii) a warm white light emitting device (LED), (iii) an infrared (IR) device, or (iv) an array of LEDS disposed in a vertical row within the first object.

In yet another variation of this embodiment, the illumination source is configured to emit illumination at a predetermined blink frequency and during an emission period and the imaging device is configured to capture image data at the predetermined blink frequency and with an exposure period at least equal to the emission period.

In still another variation of this embodiment, the one or more processors are further configured to: responsive to generating the wakeup signal, causing the imaging device to capture subsequent image data representative of the environment; and determine whether an indicia is visible in the subsequent image data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a prior art bioptic barcode reader, implemented in a prior art point-of-sale (POS) system.

FIG. 2 is a block diagram of an example logic circuit for implementing example methods and/or operations described herein.

FIG. 3 illustrates exemplary device configurations and functions for improving imaging system wakeup and indicia decoding, in accordance with embodiments disclosed herein.

FIGS. 4A-4C illustrate exemplary captured image data of a field of view (FOV) and exemplary functions of an imaging device included as part of a device for improving imaging system wakeup and indicia decoding, in accordance with embodiments disclosed herein.

FIG. 5 illustrates an example method for improving imaging system wakeup and indicia decoding, in accordance with embodiments disclosed herein.

FIG. 6 illustrates another example method for improving imaging system wakeup and indicia decoding, in accordance with embodiments disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

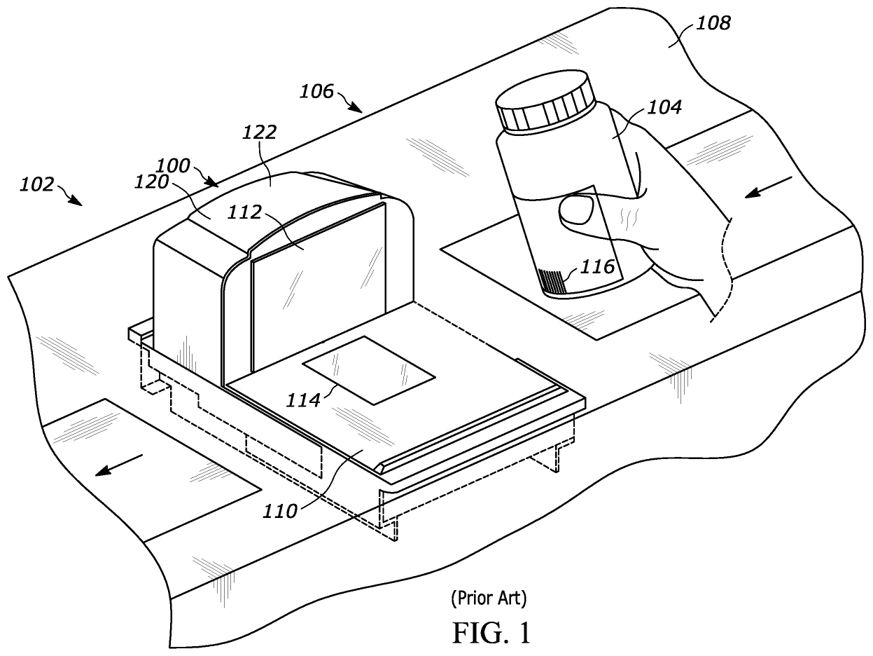

FIG. 1 is a perspective view of a prior art bioptic barcode reader 100, implemented in a prior art point-of-sale (POS) system 102, showing capture of an image of a target object 104 being swiped across the bioptic barcode reader 100 scanning area. The POS system 102 includes a workstation 106 with a counter 108, and the bioptic barcode reader 100. The bioptic barcode reader 100 includes a weighing platter 110, which may be a removable or a non-removable. Typically, a customer or store clerk will pass the target object 104 across at least one of a substantially vertical imaging window 112 or a substantially horizontal imaging window 114 to enable the bioptic barcode reader 100 to capture one or more images of the target object 104, including the barcode 116.

As part of the clerk passing the target object 104 across the imaging windows 112, 114, the bioptic barcode reader 100 may utilize an illumination source 120 during an inactive period/state characterized by the illumination source 120 emitting a relatively low level of illumination to allow the imaging sensor 122 to capture image data of the weighing platter 110 at a reduced/low capture rate and/or otherwise modified manner. When the image data indicates an object present within the FOV of the imaging sensor 122, the bioptic barcode reader 100 may cause the illumination source 120 and imaging sensor 122 to “wakeup,” into an active period/state in that the illumination source 120 may emit a higher level of illumination than during the inactive period/state, and the imaging sensor 122 may capture subsequent image data at an increased/high capture rate and/or otherwise modified manner relative to the inactive period/state. In this manner, the prior art bioptic barcode reader 100 may cause the imaging sensor 122 to capture image data of the target object 104 and/or the barcode 116 during the active period/state for potential decoding of the barcode 116.

However, as previously mentioned, this conventional wakeup sequence yields several undesirable results. Namely, the illumination source 120 and the imaging senor 122 emitting illumination and/or capturing image data through the substantially vertical imaging window 112 and/or the substantially horizontal imaging window 114 can lack sufficient range to reliably identify when a target object 104 is placed proximate to the weighing platter 110 for indicia decoding. Thus, the indicia decoding process (and by extension, the checkout process) can be needlessly delayed while a user/customer attempts to adequately position the target object 104 in a manner sufficient to trigger the conventional wakeup sequence. Further, conventional wakeup sequences may also aggravate/stress users' eyes as the illumination emitted by the illumination source 120 may be oriented towards a user attempting to activate the wakeup sequence and scan/decode a target object indicia. This issue may be additionally compounded by the previously mentioned range issue, such that a user may have excess levels of illumination aggravating/stressing the user's eyes for longer than necessary while the conventional system (e.g., prior art bioptic barcode reader 100) struggles to recognize a target object 104 positioned proximate to the weighing platter 110.

To resolve these issues with conventional systems, the present disclosure provides technologies for improving imaging system wakeup and indicia decoding. An example device includes an imaging device disposed proximate to a first edge of a weighing platter of an imaging system, and having a field of view (FOV) including a first object disposed proximate to a second edge of the weighing platter; an illumination source disposed proximate to the first edge of the weighing platter, the illumination source being configured to emit illumination oriented towards the first object; and one or more processors. The one or more processors may be configured to: cause the illumination source to emit illumination, cause the imaging device to capture image data representative of an environment appearing within the FOV, determine that a second object satisfies a position threshold relative to at least one of the imaging device or the first object, and generate a wakeup signal to activate the imaging system. Accordingly, the technologies of the present disclosure alleviate the issues associated with conventional systems by, inter alia, having illumination and imaging devices more proximate to a user and oriented away from the user. In this manner, the technologies of the present disclosure enable users to activate the wakeup sequence by positioning objects over a weighing platter with less discretion while simultaneously avoiding aggravating/stressful illumination emissions into the user's eyes.

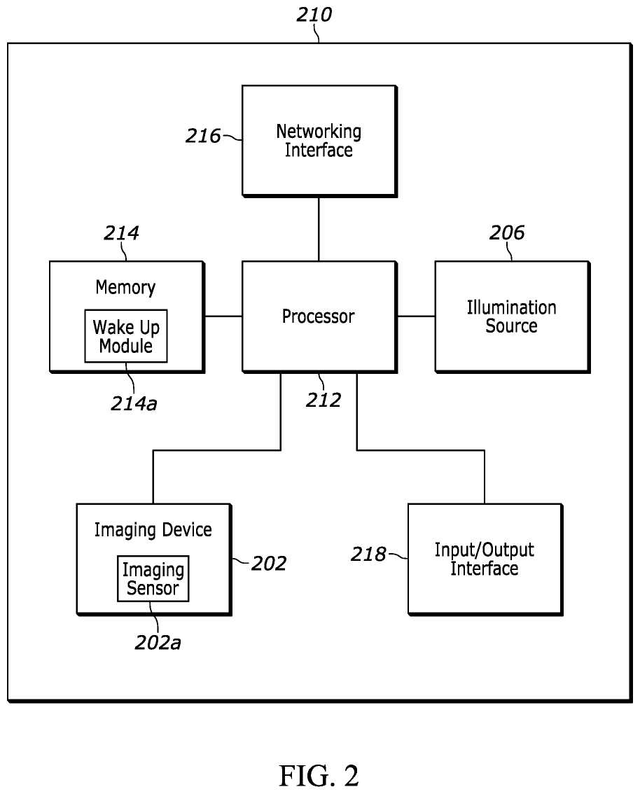

FIG. 2 is a block diagram representative of an example logic circuit capable of implementing, for example, one or more components of the example systems and methods described herein. The example logic circuit of FIG. 2 is a processing platform 210 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 210 of FIG. 2 includes a processor 212 such as, for example, one or more microprocessors, controllers, and/or any suitable type of processor. The example processing platform 210 of FIG. 2 includes memory (e.g., volatile memory, non-volatile memory) 214 accessible by the processor 212 (e.g., via a memory controller). The example processor 212 interacts with the memory 214 to obtain, for example, machine-readable instructions stored in the memory 214 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 210 to provide access to the machine-readable instructions stored thereon.

As an example, the example processor 212 may interact with the memory 214 to access and execute instructions related to and/or otherwise comprising the wakeup module 214a. the wakeup module 214a may generally include instructions that cause the processors 212 to: cause the illumination source 206 to emit illumination; cause the imaging device 202 to capture image data representative of an environment appearing within the FOV (e.g., via the imaging sensor 202a); determine, based on the image data, that a second object satisfies a position threshold relative to at least one of the imaging device 202 or the first object, and/or generate a wakeup signal to activate an imaging system. Of course, the wakeup module 214a may include additional instructions, such as cause the imaging device to capture a first set of image data while the illumination source is inactive; after the imaging device captures the first set of image data, cause (i) the illumination source to emit illumination and (ii) the imaging device to capture a second set of image data; and determine an object differential brightness between a first set of pixel data representing the second object in the first set of image data and a second set of pixel data representing the second object in the second set of image data; and/or any other suitable instructions or combinations thereof.

As illustrated in FIG. 2, the first imaging apparatus 202 includes imaging sensor(s) 202a. The imaging sensor(s) 202a may include one or more sensors configured to capture image data corresponding to a target object, an indicia associated with the target object, and/or any other suitable image data. More generally, the imaging sensor(s) 202a may be or include a visual imager (also referenced herein as a “vision camera”) with one or more visual imaging sensors that are configured to capture one or more images of a target object. Additionally, or alternatively, the imaging sensor(s) 202a may be or include a barcode scanner with one or more barcode imaging sensors that are configured to capture one or more images of an indicia associated with the target object. Moreover, the illumination source 206 may generally be configured to emit illumination during a predetermined period in synchronization with image capture of the imaging device 202. The imaging device 202 may be configured to capture image data during the predetermined period, thereby utilizing the illumination emitted from the illumination source 206.

The example processing platform 210 of FIG. 2 also includes a network interface 216 to enable communication with other machines via, for example, one or more networks. The example network interface 216 includes any suitable type of communication interface(s) (e.g., wired and/or wireless interfaces) configured to operate in accordance with any suitable protocol(s). For example, in some embodiments, networking interface 216 may transmit data or information (e.g., imaging data and/or other data described herein) between the processing platform 210 and any suitable connected device(s).

The example, processing platform 210 of FIG. 2 also includes input/output (I/O) interfaces 218 to enable receipt of user input and communication of output data to the user.

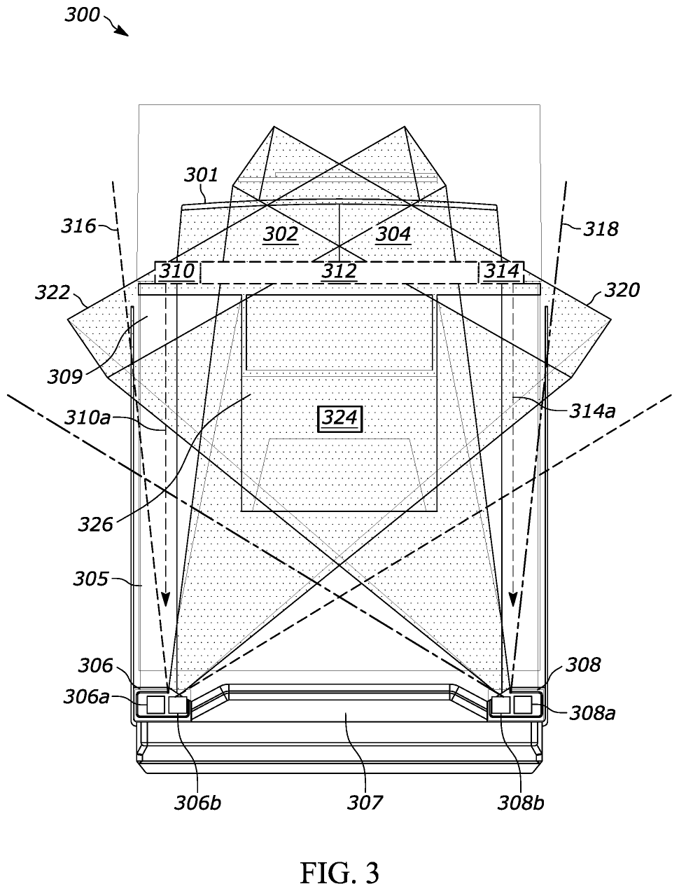

To illustrate some of the systems and components used for improving imaging system wakeup and indicia decoding, FIG. 3 provides an overhead view of an example imaging system 300 that includes a bioptic tower portion 301, a first device 306 disposed proximate to a first edge 307 of a weighing platter 305, and a second device 308 disposed proximate to the first edge 307 of the weighing platter 305. The example imaging system 300 may be any suitable type of imaging device, such as a bioptic barcode scanner, a slot scanner, an original equipment manufacturer (OEM) scanner inside of a kiosk, a handle/handheld scanner, and/or any other suitable imaging device type. For ease of discussion only, the example imaging system 300 may be described herein as a bioptic barcode scanner.

Generally speaking, the bioptic tower portion 301 may be disposed proximate to a second edge 309 of the weighing platter 305 that is different from the first edge 307. The bioptic tower portion 301 may also include an imaging device 302 and an illumination source 304 that are generally in an inactive state until awakened in response to a wakeup signal generated by the first device 306 and/or the second device 308. For example, this inactive state may generally be or include the imaging device 302 and/or the illumination source 304 being completely inactive, such that the imaging device 302 captures no image data and the illumination source 304 emits no illumination while inactive. As another example, the inactive state may be or include the imaging device 302 and/or the illumination source 304 being substantially inactive, such that the imaging device 302 captures infrequent and/or otherwise minimal image data and the illumination source 304 emits infrequent, low intensity, and/or otherwise minimal illumination while inactive.

In any event, during this inactive state, the first device 306 and/or the second device 308 may capture and analyze image data to determine whether a wakeup signal should be generated to activate/wakeup the imaging device 302, the illumination source 304, and/or any other suitable components of the example imaging system 300 or combinations thereof. Namely, and broadly speaking, if the first device 306 and/or the second device 308 determine that an object has passed into the FOV (e.g., first FOV 320 or second FOV 322), then the devices 306, 308 may also determine that a user is attempting to cause the example imaging system 300 to capture an indicia of the object as part of a checkout sequence, for example. Thus, to achieve this object detection, the first device 306 and/or the second device 308 may emit illumination via their respective illumination sources 306a, 308a, and may capture image data representative of the environments appearing with the respective FOVs 320, 322 via their respective imaging devices 306b, 308b. Such image data, as referenced herein, may generally comprise 1-dimensional (1D) and/or 2-dimensional (2D) images of a target object (e.g., object 324), including, for example, packages, products, or other target objects that may or may not include barcodes, QR codes, or other such labels for identifying such packages, products, or other target objects, which may be, in some examples, merchandise available at retail/wholesale store, facility, or the like.

More generally, the bioptic tower portion 301 (and/or other portions of the example imaging system 300) may appear within the FOVs 320, 322 of the respective devices 306, 308. For example, the bioptic tower portion 301 may be a first object disposed in the environment represented in captured image data of the respective FOVs 320, 322. In this example, the bioptic tower portion 301 may be a portion of a bioptic reader comprising a housing and an optical window. This optical window may be a substantially vertical optical window positioned at a front face of the bioptic tower portion 301 that is visible in the respective FOVs 320, 322, but not visible in FIG. 3 due to the overhead orientation. Further in this example, the imaging device 302 and the illumination source 304 may be associated with the bioptic reader and disposed within the housing and proximate to the optical window.

As a practical example of the example imaging system 300 of FIG. 3, a clerk and/or other user may bring a target object 324 into the FOVs 320, 322 of the respective devices 306, 308 as part of a checkout session. In this example, the first edge 307 may be proximate to the user, such that the user is positioned beyond the first edge 307 and facing a direction similar to the orientation of the respective FOVs 320, 322. As the user passes the target object 324 through the respective FOVs 320, 322, one or both of the devices 306, 308 may have their respective illumination sources 306a, 308a emitting illumination, and may cause their respective imaging devices 306b, 308b to capture image data of the environment represented by the respective FOVs 320, 322. This image data may include the target object 324, and the devices 306, 308 may analyze the image data to determine that the target object 324 is present within the image data. Accordingly, the first device 306 and/or the second device 308 may generate a wakeup signal configured to activate the imaging device 302 and/or the illumination source 304 within the bioptic tower portion 301 to capture image data of the target object through the substantially vertical optical window and/or the substantially horizontal optical window 326.

Broadly, the first device 306 and the second device 308 may be configured in any suitable manner to capture image data of the environment appearing within the FOVs 320, 322. However, in certain embodiments, the example imaging system 300 may only include one of the devices 306, 308. In some embodiments, the devices 306, 308 may simultaneously emit illumination through their respective illumination sources 306a, 308a, and may similarly simultaneously capture image data of their respective FOVs 320, 322 through their respective imaging devices 306b, 308b. In embodiments where the devices 306, 308 capture image data simultaneously, the devices 306, 308 may be communicatively coupled and configured to analyze the captured image data, independently determine whether a wakeup signal should be generated, and reach consensus regarding the wakeup signal generation based on the independent determinations. For example, the first device 306 may capture image data that includes the object 324, but the object 324 may not appear within the FOV 322 of the second device 308. In this example, the first device 306 may analyze the captured image data to determine that a wakeup signal should be generated, but the second device 308 may determine that a wakeup signal should not be generated. The two devices 306, 308 may communicate and/or otherwise share the respective determinations, and may determine that the wakeup signal should be generated based on the analysis performed by the first device 306. Additionally, or alternatively, the captured image data from both devices 306, 308 may be analyzed simultaneously by a central processor, which may make the consensus decision regarding wakeup signal generation based on the two sets of captured image data.

In the prior example, and as referenced herein, various objects may be included in the environment represented within the respective FOVs of the devices 306, 308, such as the bioptic tower portion 301. In certain embodiments, the bioptic tower portion 301 may be a first object within the FOV, and the devices 306, 308 may cause their respective illumination sources 306a, 308a to emit illumination oriented towards the bioptic tower portion 301 as the first object. Similarly, the devices 306, 308 may cause their respective imaging devices 306b, 308b to capture image data representative of the environment appearing within the respective FOVs 320, 322 that are generally oriented towards the bioptic tower portion 301 as the first object.

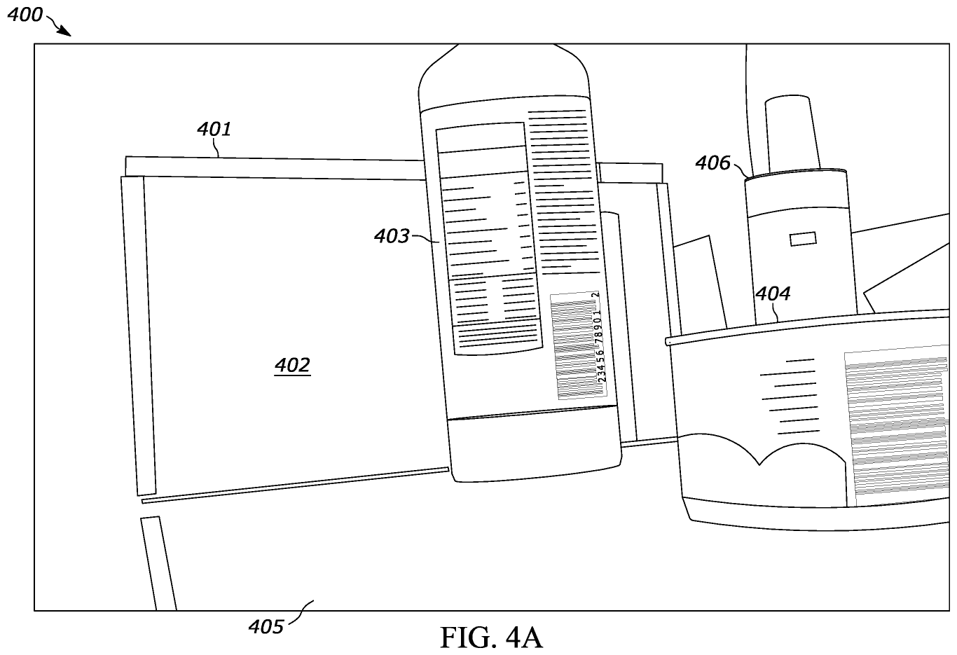

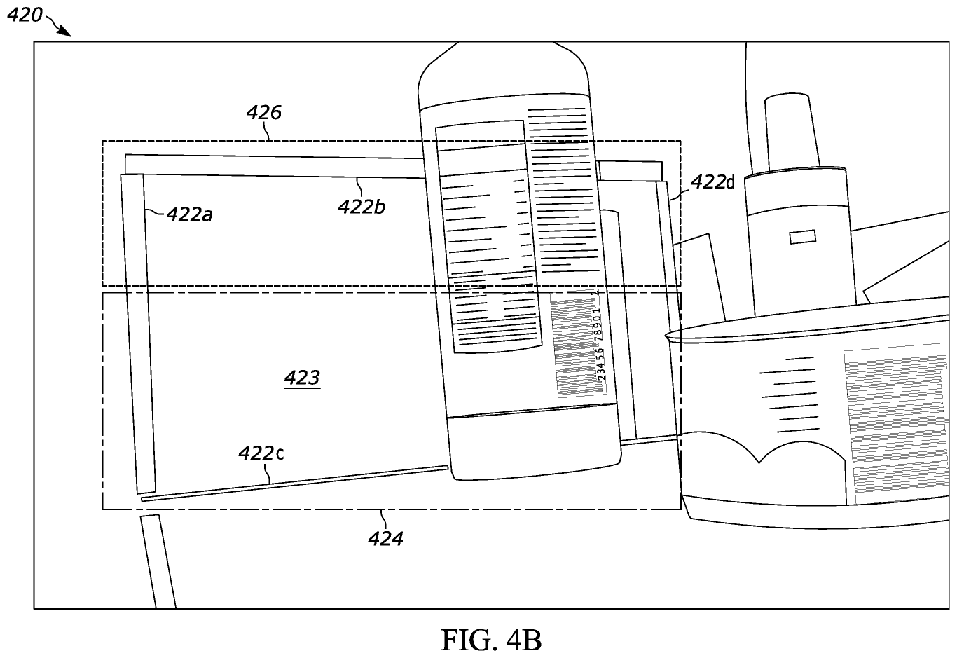

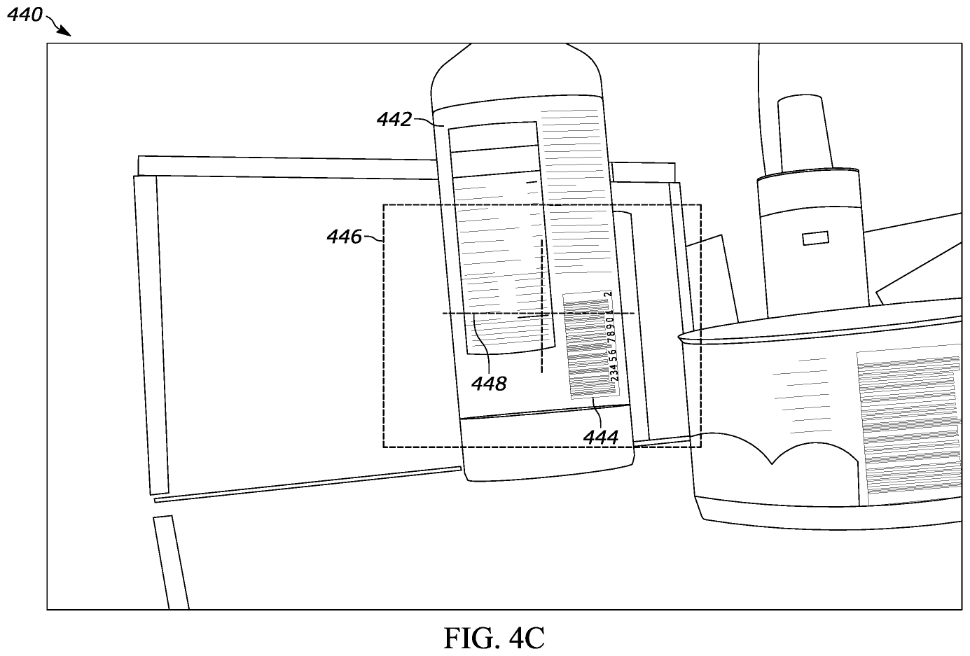

More specifically, captured image data associated with an exemplary FOV 400 (e.g., FOV 320) for an imaging device (e.g., imaging device 306a) is illustrated in FIG. 4A. In this exemplary FOV 400 the bioptic tower portion 401 may be a first object within the environment that appears within the FOV 400. The bioptic tower portion 401 may include a substantially vertical optical window 402, through which, imaging components of the bioptic tower (e.g., imaging device 302, illumination source 304) may capture image data. The exemplary FOV 400 may also feature multiple objects 403, 404 that are disposed on the weighing platter 405. In the exemplary FOV 400 of FIG. 4, these objects 403, 404 may be a second object and a third object, respectively. Moreover, the image data represented by the exemplary FOV 400 may also include a fourth object 406 that is not positioned on the weighing platter 405. Thus, the second object 403 and the third object 404 are positioned in a manner that is indicative of a user's intent to activate the imaging system and thereby decode indicia associated with these objects 403, 404. However, the fourth object 406 is not positioned on the weighing platter and/or otherwise positioned in a manner that indicates a user's intent to activate the imaging system.

To make these determinations regarding whether to activate the imaging system and decode indicia associated with objects within the FOV 400, the device (e.g., device 306, 308) configured to capture the image data represented by the exemplary FOV 400 may execute instructions configured to distinguish between objects that should result in the generation of a wakeup signal (e.g., second object 403, third object 404) and those that should not (e.g., fourth object 406). In particular, the device may determine whether to generate a wakeup signal based on whether the position of any object 403, 404, 406 within the environment satisfies a position threshold. Such a position threshold may, for example, may indicate proximity of the object 403, 404, 406 to the first object 401 and/or the device (e.g., devices 306, 308), positioning of the object 403, 404, 406 between the first object 401 and the device (e.g., device 306, 308), and/or any other suitable value(s) or combinations thereof. In certain embodiments, the device (e.g., device 306, 308) may determine whether an object satisfies the position threshold based on the position of the object relative to at least one of the device, the first object, and/or another object (e.g., relative to third object 404).

In some embodiments, the devices (e.g., 306, 308) may make the wakeup signal generation determinations using additional/other properties of the captured image data beyond positions of objects within the environment appearing within the FOV. For example, the devices may utilize object differential brightness to determine when an object (e.g., objects 403, 404) within the FOV is positioned in a manner that should necessitate wakeup signal generation. Namely, the devices may cause the respective imaging device(s) (e.g., imaging device 306b, 308b) to capture a first set of image data while the respective illumination source (e.g., illumination source 306a, 308a) is inactive. After the imaging device captures the first set of image data, the devices may cause (i) the illumination sources to emit illumination and (ii) the imaging devices to capture a second set of image data. Additionally, or alternatively, the imaging device(s) may capture the first set of image data while the respective illumination source is active, and the imaging device(s) may capture the second set of image data while the respective illumination source is inactive.

In any event, the devices of the prior example may then determine an object differential brightness between a first set of pixel data representing the second object (e.g., second object 403, third object 404, fourth object 406) in the first set of image data and a second set of pixel data representing the second object in the second set of image data. As illustrated in FIG. 4A, the second object 403 and the third object 404 may have an object differential brightness sufficient to trigger wakeup signal generation, while the fourth object 406 may not have an object differential brightness sufficient to trigger the wakeup signal generation. Moreover, in these embodiments, determining the object differential brightness may be limited to certain portions of the FOV, such that objects in positions similar to the fourth object 406 may not trigger wakeup signal generation due to being outside of the FOV portion analyzed for object differential brightness.

In some embodiments, the devices may also utilize components installed and/or otherwise present on the bioptic tower portion 301, 401 to determine whether to generate a wakeup signal. For example, FIG. 4B illustrates an exemplary FOV 420 of a device (e.g., devices 306, 308), wherein the devices may determine whether to generate a wakeup signal based on image data representing objects juxtaposed with components of the bioptic tower portion 301, 401. In the example of FIG. 4B, the bioptic tower portion may include various strips 422a, 422b, 422c, 422d positioned along the exterior edges of the substantially vertical optical window 423. In certain embodiments, these strips 422a, 422b, 422c, 422d may be retroreflector strips configured to reflect illumination emitted from the respective illumination source(s) (e.g., illumination source 306a, 308a) of the respective device(s) (e.g., device 306, 308) determining whether to generate a wakeup signal. The devices may include and/or otherwise access instructions indicating an expected or threshold brightness/contrast/etc. resulting from emitted illumination reflecting from the strips 422a, 422b, 422c, 422d and returning to the imaging devices 306b, 308b. The devices may thereby analyze the captured image data to determine whether any of these thresholds or expected values are not met, indicating that a portion of the retroreflector strips 422a, 422b, 422c, 422d is/are covered by an object. Accordingly, the devices may determine that a wakeup signal should be generated because an object is positioned between the device and the bioptic tower portion (e.g., particularly, the retroreflector strips 422a, 422b, 422c, 422d). As discussed further herein, the strips 422a, 422b, 422c, 422d may also be or include other components or materials, such as illumination sources (e.g., light emitting diodes (LEDs)) configured to emit illumination oriented towards the devices (e.g., device 306, 308), and/or may be of any suitable dimension or shape (e.g., periodic dots).

Additionally, the first and second devices 306, 308 may include/access instructions configured to adjust an emission profile of the illumination sources 306a, 308a to further reduce eye irritation caused by emitted illumination. The illumination sources 306a, 308a may be comprised of multiple LEDs and/or other suitable illumination devices, and the number of LEDs that are activated to emit illumination during any particular image capture sequence and/or during any particular period of the inactive state may be adjusted to tailor the emission profile of the illumination sources 306a, 308a. For example, the first and/or second device 306, 308 may adjust an emission profile of the illumination sources 306a, 308a, such that the illumination source 306a, 308a is configured to emit the illumination over a first portion 424 of the first object (e.g., bioptic tower portion 301, 401). Of course, the first and/or second devices 306, 308 may be configured to adjust the emission profile of the illumination sources 306a, 308a over any suitable portion(s) of the bioptic tower portion and/or any other area of the FOVs 320, 322, such as the second portion 426 of the first object.

Moreover, the first and second imaging devices 306, 308 may be configured to compare captured image data to determine whether there is an issue with either/both imaging devices 306, 308. For example, certain objects brought into the FOVs 320, 322 (e.g., onions) may obscure portions of the FOV by contacting and/or otherwise being positioned in front of the imaging devices 306b, 308b (or the illumination sources 306a, 308a). When the devices 306, 308 are obscured for any reason (e.g., particulate matter, dirt, dust, etc.) their captured image data and resulting analysis may be erroneous and/or otherwise skewed.

To avoid these potential issues, the first and second devices 306, 308 may cause the first imaging device 306b and the second imaging device 308b to capture a plurality of pairs of image data sets, wherein each pair of image data sets includes a respective second object (e.g., target object 324) in at least one image data set. The first and/or second device 306, 308 may then determine that multiple pairs of image data sets from the plurality of pairs of image data sets includes respective second objects in only one image data set. Accordingly, the first and/or second device 306, 308 may generate a cleaning alert and/or other suitable alert (e.g., blocked imaging device alert) corresponding to a respective device 306, 308 that captured an image data set that did not include a respective second object. In other words, if the first imaging device 306b is obscured by an onion peel and/or any other suitable object (e.g., scannable item, debris, etc.) and the second imaging device 308b is not, then the image data from the first imaging device 306b may not feature a target object 324 that is featured in the image data from the second imaging device 308b. The user may receive the cleaning alert, recognize the onion peel obscuring the first imaging device 306b, and may remove the onion peel and/or otherwise clean the first imaging device 306b and/or the first illumination source 306a.

Of course, it should be appreciated that the FOVs 320, 322 illustrated in the example imaging system 300 of FIG. 3 are for the purposes of illustration/discussion only, and that the first device 306 and/or the second device 308 may have any suitable FOVs 320, 322 with any suitable breadth and/or range. For example, the first FOV 320 corresponding to the first device 306 may, in certain embodiments, extend to the degree indicated by the first FOV lines 316, and the second FOV 322 corresponding to the second device 308 may extend to the degree indicated by the second FOV lines 318. In this example, the first device 306 and the second device 308 may have FOVs that fully represent the front face of the bioptic tower portion 301, and may thus receive illumination emitted from one or both of the tower side illumination sources 310, 314.

In certain embodiments, the first and second devices 306, 308 may determine whether to generate a wakeup signal based on illumination sources 310, 314 disposed within the bioptic tower portion 301, 401. The FOVs 320, 322 of the first and second imaging devices 306b, 308b may further extend to the boundaries represented by the FOVs 316, 318, and more generally, to any suitable boundaries. Regardless, the illumination sources 310, 314 may be LED strips and/or other suitable illumination devices configured to emit illumination oriented towards the first and second devices 306, 308 (as illustrated by the orientation arrows 310a, 314a) to function as a beam break configuration.

While the first and second devices 306, 308 are capturing image data during the inactive state/period, the illumination sources 310, 314 may continuously emit illumination oriented towards the devices 306, 308, such that the emitted illumination from the sources 310, 314 is always present in the captured image data. Consequently, as a target object 324 passes through/in front of the illumination emitted by the illumination sources 310, 314, the captured image data at either the first or the second device 306, 308 may include no/less illumination from the respective source(s) 310, 314. The devices 306, 308 may thereby detect this beam break caused by the target object 324 passing through the emitted illumination from the source(s) 310, 314, and may determine that the imaging system 300 should be activated.

In some embodiments, the illumination sources 310, 314 and/or any other suitable illumination sources (e.g., illumination sources 304, 306a, 308a) may be or include: (i) a lightpipe strip, (ii) a warm white LED, (iii) an infrared (IR) device, (iv) an array of LEDs disposed in a vertical row within the first object, (v) a red LED and/or any other suitable color(s) LED, and/or any other suitable illumination component or combinations thereof. Further, in certain embodiments, any of the illumination sources 304, 306a, 308a, 310, 314 may be configured to emit illumination at a predetermined blink frequency and/or during an emission period. In these embodiments, the first and/or second imaging devices 306b, 308b may be configured to capture image data at the predetermined blink frequency and/or with an exposure period at least equal to the emission period.

Moreover, the illumination sources 304, 306a, 308a, 310, 314 may include multiple LEDs and multiple lenses in order to provide optimal illumination for the first imaging device 306b and/or the second imaging device 308b. Some of the multiple lenses and/or the multiple LEDs may be optimally configured to provide illumination for the first imaging device 306b, such that some/all of the first FOV 316, 320 is illuminated with light that optimally illuminates the target object 324 for wakeup signal generation determinations. Similarly, some of the multiple lenses and/or the multiple LEDs may be optimally configured to provide illumination for the second imaging device 308b, such that some/all of the second FOV 318, 322 is illuminated with light that optimally illuminates the target object 324 for wakeup signal generation determinations.

As part of this optimal illumination, the illumination sources 304, 306a, 308a, 310, 314 may be configured to provide illumination sufficient to enable the first and/or second imaging devices 306b, 308b to also perform indicia decoding of the target object 324. In certain embodiments, the first device 306 and/or the second device 308 may determine that a wakeup signal should be generated, and may proceed to capture subsequent image data of the target object 324. Thereafter, the first device 306 and/or the second device 308 may analyze the subsequent image data to determine whether an indicia is visible in the subsequent image data by attempting to identify and decode the indicia associated with the target object 324.

However, in the prior embodiments, the user may need to orient/position the target object 324 sufficiently for the first and/or second device 306, 308 to view the indicia associated with the target object 324. To assist the user in properly orienting/positioning the target object, the first and/or second devices 306, 308 may generate and project an aiming pattern via the first and/or second illumination sources 306a, 308a. As illustrated in FIG. 4C, the exemplary FOV 440 includes a target object 442 with an indicia 444. The first and/or second devices 306, 308 may analyze image data including the target object 442 and determine that a wakeup signal should be generated. The devices 306, 308 may then further determine that subsequent image data should be captured to facilitate indicia 444 decoding, and may cause the first/second illumination sources 306a, 308a to generate/output the aiming pattern 446 containing an aiming reticle 448. Using this aiming pattern 446 as reference, the user may adequately position the target object 442, and more specifically, the associated indicia 444 within the aiming pattern 446 and/or the aiming reticle 448 to allow the devices 306, 308 to capture subsequent image data of the target object 442. With the subsequent image data, the first and/or second device(s) 306, 308 may determine whether the indicia 444 is visible in the subsequent image data by identifying and decoding the indicia 444 associated with the target object 442. Of course, the aiming pattern 446 and/or the aiming reticle 448 illustrated in FIG. 4C are for the purposes of discussion only, and the aiming pattern 446 and the aiming reticle 448 may be of any suitable size and/or shape.

Moreover, in certain embodiments, the relative size of the aiming pattern 446 may also be used to facilitate wakeup signal generation. Namely, the aiming pattern 446 may be comprised of collimated light, such that the pattern 446 may appear relatively smaller in captured image data when the pattern 446 is projected farther away (e.g., onto the bioptic tower portion 401) and relatively larger when projected onto an object (e.g., target object 442) between the tower and imaging devices (e.g., devices 306, 308). When such a relative change in size of the aiming pattern 446 is detected in the captured image data a wakeup signal may be generated to activate additional imaging devices, illumination sources, and/or otherwise facilitate indicia 444 decoding.

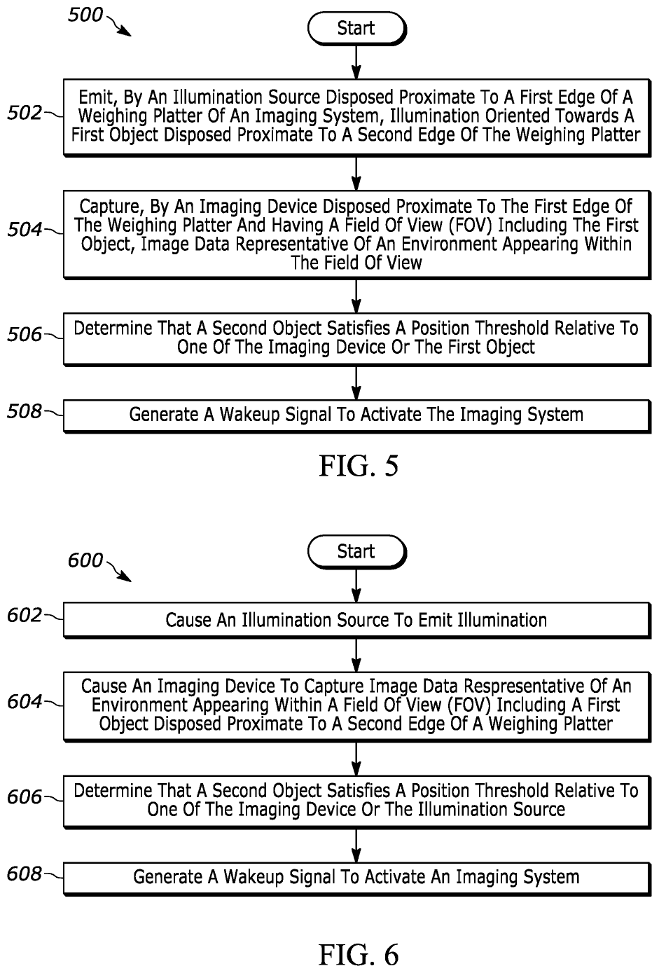

FIG. 5 illustrates an example method 500 for improving imaging system wakeup and indicia decoding, in accordance with embodiments disclosed herein. It should be appreciated that the actions described herein in reference to the example method 500 of FIG. 5 may be performed by any suitable components described herein, such as the first/second devices 306, 308, and/or combinations thereof.

The method 500 includes emitting, by an illumination source disposed proximate to a first edge of a weighing platter of an imaging system, illumination oriented towards a first object disposed proximate to a second edge of the weighing platter (block 502). The method 500 further includes capturing, by an imaging device disposed proximate to the first edge of the weighing platter and having a field of view (FOV) including the first object, image data representative of an environment appearing within the FOV (block 504).

The method 500 further includes determining, based on the image data, that a second object satisfies a position threshold relative to at least one of the imaging device or the first object (block 506). The method 500 further includes generating a wakeup signal to activate the imaging system (block 508).

In some embodiments, the first object is a portion of a bioptic reader, the bioptic reader comprising: a second imaging device having a second field of view (FOV) oriented towards the first edge of the weighing platter; and a second illumination source associated with the bioptic reader, the second illumination source being configured to emit illumination oriented towards the first edge of the weighing platter. Further in these embodiments, the imaging system comprises at least the bioptic reader, and the wakeup signal causes the bioptic reader to: emit illumination via the second illumination source; capture second image data representative of at least a portion of the second object via the second imaging device; and analyze the second image data to (i) identify an indicia associated with the second object and (ii) decode the indicia.

In certain embodiments, the illumination source and the imaging device are disposed at a first position proximate to the first edge of the weighing platter, and the wakeup device further comprises: a second imaging device disposed at a second position proximate to the first edge of the weighing platter that is different from the first position, the second imaging device having a second FOV including the first object, and the second imaging device being configured to capture second image data representative of a second environment appearing within the second FOV; and a second illumination source positioned at the second position, the second illumination source being configured to emit illumination oriented towards the first object. Further in these embodiments, the method 500 may further include: causing the first imaging device and the second imaging device to capture a plurality of pairs of image data sets, wherein each pair of image data sets includes a respective second object in at least one image data set; determining that multiple pairs of image data sets from the plurality of pairs of image data sets includes respective second objects in only one image data set; and generating a cleaning alert corresponding to a respective imaging device that captured an image data set that did not include a respective second object.

In some embodiments, the method 500 may further include: causing the imaging device to capture a first set of image data while the illumination source is inactive; after the imaging device captures the first set of image data, causing (i) the illumination source to emit illumination and (ii) the imaging device to capture a second set of image data; and determining an object differential brightness between a first set of pixel data representing the second object in the first set of image data and a second set of pixel data representing the second object in the second set of image data.

In certain embodiments, the image data includes at least a third object, and the method 500 may further include: determining, based on the image data, that the second object satisfies the position threshold relative to at least one of the imaging device, the first object, or the third object; and generating the wakeup signal to activate the imaging system.

In some embodiments, the method 500 may further include: responsive to generating the wakeup signal, causing the imaging device to capture subsequent image data representative of the environment; and determining whether an indicia is visible in the subsequent image data. Further in these embodiments, the illumination source is further configured to output an aiming pattern corresponding to the imaging system attempting to scan an indicia associated with the second object.

In certain embodiments, the method 500 may further include: adjusting an emission profile of the illumination source, such that the illumination source is further configured to emit the illumination over a first portion of the first object.

In some embodiments, the method 500 may further include: analyzing captured image data to determine that an object has passed between the imaging device that captured the captured image data and a bioptic tower portion (e.g., bioptic tower portion 401). More particularly, the three-dimensional region between the imaging device that captured the captured image data and the bioptic tower portion may be a predetermined and/or otherwise defined zone, and the target object may pass into this zone, thereby blocking some/all of the bioptic tower portion from the imaging device. In such embodiments, the illumination sources may or may not emit illumination, and the imaging devices may analyze the captured image data to determine any substantial changes to the pixels within the predetermined and/or otherwise defined zone. Thus, if the imaging devices detect a change to the pixel data representing the predetermined and/or otherwise defined zone by the pixel data exceeding a threshold value and/or otherwise substantially differing from the known pixel data values corresponding to the predetermined and/or otherwise defined zone, the imaging devices may generate a wakeup signal and/or otherwise cause a wakeup signal to be generated.

FIG. 6 illustrates another example method 600 for improving imaging system wakeup and indicia decoding, in accordance with embodiments disclosed herein. It should be appreciated that the actions described herein in reference to the example method 600 of FIG. 6 may be performed by any suitable components described herein, such as the first/second devices 306, 308, and/or combinations thereof.

The method 600 includes causing an illumination source to emit illumination (block 602). The method 600 further includes causing an imaging device to capture image data representative of an environment appearing within a FOV including a first object disposed proximate to a second edge of a weighing platter (block 604). The method 600 further includes determining that a second object satisfies a position threshold relative to at least one of the imaging device or the illumination source (block 606). The method 600 further includes generating a wakeup signal to activate an imaging system (block 608).

In some embodiments, the first object is a portion of a bioptic reader comprising a housing and an optical window, and the illumination source is associated with the bioptic reader and disposed within the housing and proximate to the optical window. Further in these embodiments, the portion of the bioptic reader includes a set of LED strips surrounding the optical window and configured to emit illumination oriented towards the imaging device.

In certain embodiments, the illumination source is at least one of: (i) a lightpipe strip, (ii) a warm white light emitting device (LED), (iii) an infrared (IR) device, or (iv) an array of LEDs disposed in a vertical row within the first object.

In some embodiments, the illumination source is configured to emit illumination at a predetermined blink frequency and during an emission period and the imaging device is configured to capture image data at the predetermined blink frequency and with an exposure period at least equal to the emission period.

In certain embodiments, the method 600 may further include: responsive to generating the wakeup signal, causing the imaging device to capture subsequent image data representative of the environment; and determining whether an indicia is visible in the subsequent image data.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A device for improving imaging system wakeup and indicia decoding, the device comprising:
an imaging device disposed proximate to a first edge of a weighing platter of an imaging system, the imaging device having a field of view (FOV) including a first object disposed proximate to a second edge of the weighing platter;
an illumination source disposed proximate to the first edge of the weighing platter, the illumination source being configured to emit illumination oriented towards the first object; and
one or more processors configured to:
cause the illumination source to emit illumination,
cause the imaging device to capture image data representative of an environment appearing within the FOV,
determine, based on the image data, that a second object satisfies a position threshold relative to at least one of the imaging device or the first object, and
generate a wakeup signal to activate the imaging system.

2. The device of claim 1, wherein the first object is a portion of a bioptic reader, the bioptic reader comprising:
a second imaging device having a second field of view (FOV) oriented towards the first edge of the weighing platter; and
a second illumination source associated with the bioptic reader, the second illumination source being configured to emit illumination oriented towards the first edge of the weighing platter.

3. The device of claim 2, wherein the imaging system comprises at least the bioptic reader, and the wakeup signal causes the bioptic reader to:
emit illumination via the second illumination source;
capture second image data representative of at least a portion of the second object via the second imaging device; and
analyze the second image data to (i) identify an indicia associated with the second object and (ii) decode the indicia.

4. The device of claim 1, wherein the illumination source and the imaging device are disposed at a first position proximate to the first edge of the weighing platter, and the wakeup device further comprises:
a second imaging device disposed at a second position proximate to the first edge of the weighing platter that is different from the first position, the second imaging device having a second FOV including the first object, and the second imaging device being configured to capture second image data representative of a second environment appearing within the second FOV; and
a second illumination source positioned at the second position, the second illumination source being configured to emit illumination oriented towards the first object.

5. The device of claim 4, wherein the one or more processors are further configured to:
cause the first imaging device and the second imaging device to capture a plurality of pairs of image data sets, wherein each pair of image data sets includes a respective second object in at least one image data set;
determining that multiple pairs of image data sets from the plurality of pairs of image data sets includes respective second objects in only one image data set; and
generating a cleaning alert corresponding to a respective imaging device that captured an image data set that did not include a respective second object.

6. The device of claim 1, wherein the one or more processors are further configured to:
cause the imaging device to capture a first set of image data while the illumination source is inactive;
after the imaging device captures the first set of image data, cause (i) the illumination source to emit illumination and (ii) the imaging device to capture a second set of image data; and
determine an object differential brightness between a first set of pixel data representing the second object in the first set of image data and a second set of pixel data representing the second object in the second set of image data.

7. The device of claim 1, wherein the image data includes at least a third object, and the one or more processors are further configured to:
determine, based on the image data, that the second object satisfies the position threshold relative to at least one of the imaging device, the first object, or the third object; and
generate the wakeup signal to activate the imaging system.

8. The device of claim 1, wherein the one or more processors are further configured to:
responsive to generating the wakeup signal, causing the imaging device to capture subsequent image data representative of the environment; and
determine whether an indicia is visible in the subsequent image data.

9. The device of claim 8, wherein the illumination source is further configured to output an aiming pattern corresponding to the imaging system attempting to scan an indicia associated with the second object.

10. The device of claim 1, wherein the one or more processors are further configured to:
adjust an emission profile of the illumination source, such that the illumination source is further configured to emit the illumination over a first portion of the first object.

11. A method for improving imaging system wakeup and indicia decoding, the method comprising:
emitting, by an illumination source disposed proximate to a first edge of a weighing platter of an imaging system, illumination oriented towards a first object disposed proximate to a second edge of the weighing platter;
capturing, by an imaging device disposed proximate to the first edge of the weighing platter and having a field of view (FOV) including the first object, image data representative of an environment appearing within the FOV;
determining, based on the image data, that a second object satisfies a position threshold relative to at least one of the imaging device or the first object; and
generating a wakeup signal to activate the imaging system.

12. The method of claim 11, further comprising:
capturing, by the imaging device, a first set of image data while the illumination source is inactive;
after the imaging device captures the first set of image data:
emitting illumination from the illumination source, and
capturing, by the imaging device, a second set of image data; and
determining an object differential brightness between a first set of pixel data representing the second object in the first set of image data and a second set of pixel data representing the second object in the second set of image data.

13. The method of claim 11, wherein the image data includes at least a third object, and the method further comprises:
determining, based on the image data, that the second object satisfies the position threshold relative to at least one of the imaging device, the first object, or the third object; and
generating the wakeup signal to activate the imaging system.

14. The method of claim 11, further comprising:
responsive to generating the wakeup signal, capturing, by the imaging device, subsequent image data representative of the environment; and
determining whether an indicia is visible in the subsequent image data.

15. A device for improving imaging system wakeup and indicia decoding, the device comprising:
an imaging device disposed proximate to a first edge of a weighing platter of an imaging system, the imaging device having a field of view (FOV) including a first object disposed proximate to a second edge of the weighing platter;
an illumination source disposed in the first object and configured to emit illumination oriented towards the imaging device; and
one or more processors configured to:
cause the illumination source to emit illumination,
cause the imaging device to capture image data representative of an environment appearing within the FOV,
determine, based on the image data, that a second object satisfies a position threshold relative to at least one of the imaging device or the illumination source, and
generate a wakeup signal to activate the imaging system.

16. The device of claim 15, wherein the first object is a portion of a bioptic reader comprising a housing and an optical window, and the illumination source is associated with the bioptic reader and disposed within the housing and proximate to the optical window.

17. The device of claim 16, wherein the portion of the bioptic reader includes a set of LED strips surrounding the optical window and configured to emit illumination oriented towards the imaging device.

18. The device of claim 15, wherein the illumination source is at least one of: (i) a lightpipe strip, (ii) a warm white light emitting device (LED), (iii) an infrared (IR) device, or (iv) an array of LEDs disposed in a vertical row within the first object.

19. The device of claim 15, wherein the illumination source is configured to emit illumination at a predetermined blink frequency and during an emission period and the imaging device is configured to capture image data at the predetermined blink frequency and with an exposure period at least equal to the emission period.

20. The device of claim 15, wherein the one or more processors are further configured to:
responsive to generating the wakeup signal, causing the imaging device to capture subsequent image data representative of the environment; and
determine whether an indicia is visible in the subsequent image data.
